(19) United States
(12) Patent Application Publication
(10) Pub. No.: US 2024/0300563 A1
(43) Pub. Date: Sep. 12, 2024

(54) PALLET LIFT

(71) Applicants: Peter Douglas Jackson, Alpharetta, GA (US); Dane Gin Mun Kalinowski, Foothill Ranch, CA (US); Joseph E. Popovits, II, Costa Mesa, CA (US)

(72) Inventors: Peter Douglas Jackson, Alpharetta, GA (US); Dane Gin Mun Kalinowski, Foothill Ranch, CA (US); Joseph E. Popovits, II, Costa Mesa, CA (US)

(21) Appl. No.: 18/599,488

(22) Filed: Mar. 8, 2024

Related U.S. Application Data
(60) Provisional application No. 63/450,925, filed on Mar. 8, 2023.

(51) Int. Cl. B62B 3/06; B66F 9/12; B66F 9/24

(52) U.S. Cl. CPC B62B 3/0612; B62B 3/0625; B66F 9/125; B66F 9/24; B62B 2206/003

(57) ABSTRACT

A pallet lift includes a base and at least one platform for supporting an object thereon. The at least one platform extends forward of the base. A plurality of load wheels are below the at least one platform and configured to move toward and away from the platform to selectively lower and raise the platform. A plurality of load motors are each configured to drive one of the plurality of load wheels. At least one rear wheel is positioned below the base. At least one processor is programmed to control the plurality of load motors to provide differential steering to the pallet lift.

### BACKGROUND

In the delivery industry box trucks are becoming a common choice to make many types of deliveries. They offer value over tractor trailers for many delivery routes because drivers do not need a commercial driver license to operate them (large labor pool, non-specialized), and typically box trucks are cheaper to operate and are more maneuverable than tractor trailers.

A major challenge with box truck deliveries is transporting product from the elevated truck bed to ground level. To overcome this, box trucks are equipped with either a hydraulic liftgate, or a long (10-14′) ramp which is stowed underneath the truck while en route.

Incorporation of Lithium-ion batteries into material handling equipment significantly reduces the weight of the equipment, but also changes the load distribution. Standard electric pallet jack lead-acid or similar batteries weigh anywhere from 800-1200 lb total. Depending on the application, a Lithium-ion battery can reduce that weight to approximately 20 lb, for example. This significantly reduces the weight over the rear, single-drive tire, which at times will not be sufficient to maintain traction and prevent slipping when the pallet jack may be carrying up to 3000-4000 lb. Removing the battery weight makes the equipment much more sensitive to the load mass center relative to the drive wheel to maintain traction.

In some applications, it is desirable to make the delivery equipment as compact and maneuverable as possible to facilitate movement throughout a store or restaurant and into the coolers or freezers to maximize the delivery efficiency. As mentioned above, for traction, the load center should be biased towards the drive wheel; however, making a shorter wheelbase (from load idlers wheels to drive wheel) contradicts that need.

### SUMMARY

In several embodiments disclosed herein, the load wheels under the fork tines of the electric pallet jack are powered, such as by compact hub motors, to provide additional drive and traction due to the load center of product being transported by the electric pallet jack. This allows the electric pallet jack to be smaller in size while still maintaining a large load capacity. It also expands the functionality of the electric pallet jack by allowing it to operate on “non-standard” warehouse terrain such as ramps (e.g. into stores or restaurants) and the elements (e.g. rain or snow) to maintain traction and not lose grip during transport. By powering the load wheels, the traction, drive system and load capacity are improved while keeping the equipment small, lighter weight, and maneuverable.

Optionally, a processor controls the motors driving the load wheels to implement differential steering. The two load wheel motors may be driven independently to provide differential steering, which maximizes maneuverability by minimizing the turn radius of the equipment.

The processor may receive a steering input from the operator (e.g. via a sensor measuring the position of the tiller arm, steering wheel, yoke system, etc.) and it adjusts the speeds of each load wheel motor based on the steering angle. This minimizes excessive tread wear due to wheel drag while maintaining traction and minimizing turn radius.

### BRIEF DESCRIPTION OF THE DRAWINGS

FIG. 1 shows a first embodiment of a pallet lift.

FIG. 2 is a side view of the pallet lift in the raised position, such as would be used to raise a pallet.

FIG. 3 shows the pallet lift of FIG. 2 traveling down a ramp.

FIG. 4 is a front view of the pallet lift of FIG. 1.

FIG. 5 is a front view of the pallet lift of FIG. 1 with the platform tilted back.

FIG. 6 is a front view of the pallet lift of FIG. 3, with the tines raised, the platform tilted back.

FIG. 7 is a front perspective view of the pallet lift of FIG. 3.

FIG. 8 is a front perspective view of the pallet lift of FIG. 5.

FIG. 9 is a front perspective view of the pallet lift of FIG. 3.

FIG. 10 is a side view of the pallet lift of FIG. 3.

FIG. 11 is a bottom perspective view of the pallet lift.

FIG. 12 is a partially exploded view of the pallet lift with the platform removed for visibility.

FIG. 13 is a partially exploded upper rear view of the base of the pallet lift.

FIG. 14 is a partially exploded front view of the base of the pallet lift.

FIG. 15 shows one possible schematic of the pallet lift.

FIG. 16 shows the pallet lift carrying a pallet on the platform down a ramp between a truck and ground.

FIG. 17 shows a pallet lift according to another embodiment.

FIG. 18 is a bottom view of an outer end of one of the tines of the pallet lift of FIG. 17.

FIG. 18A shows one possible schematic of the pallet lift of FIG. 17.

FIG. 19 shows a pallet lift according to another embodiment.

FIG. 20 is a rear perspective view of the pallet lift of FIG. 19.

FIG. 20A shows one possible schematic of the pallet lift of FIG. 19.

FIG. 21 shows a pallet lift according to another embodiment.

FIG. 22 is a rear perspective view of the pallet lift of FIG. 21.

FIG. 22A shows one possible schematic of the pallet lift of FIG. 21.

FIG. 23 shows a pallet lift according to another embodiment.

### DETAILED DESCRIPTION

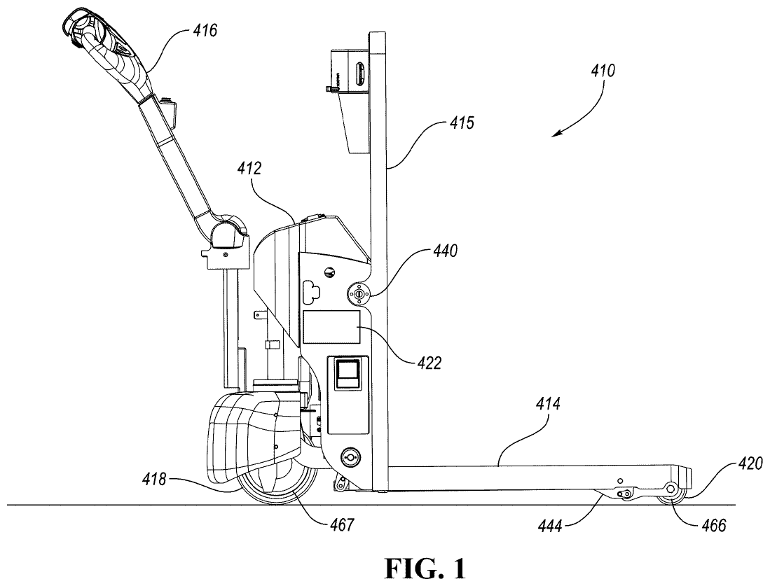

FIG. 1 shows one embodiment of a pallet lift 410. The pallet lift 410 includes a base 412 and a lower structure 444 extending forward from the base 412. A backrest 415 extends upward from a rear end of a platform 414 that extends over the lower structure 444. The platform 414 and the backrest 415 are secured to one another or formed integrally to form a rigid L-shaped member. The backrest 415 is pivotably secured to the base 412 at an axis 440. The axis 440 is horizontal, i.e. generally parallel to the floor and parallel to the axes of the load wheels 420 and spaced upward away from the platform 414.

A tiller arm 416 is pivotably connected to the base 412 and is used to steer and control the pallet lift 410. A rear wheel 418 is mounted below the base 412 and may be pivoted about a vertical axis by the tiller arm 416 to provide steering.

Load wheels 420 (two in this example, but only one is visible in FIG. 1) support the lower structure 444 below the platform 414. The platform 414 may comprise a solid platform (as shown in this example) or a pair of spaced-apart tines, depending on the type of pallets are to be used with the pallet lift 410.

The load wheels 420 are motorized, such as by having hub motors 466 therein to drive, brake and control the pallet lift 410. The rear wheel 418 may also be motorized, such as by having a hub motor 467 therein, or by being driven by a motor in the base 412 connected to the rear wheel 418 by a belt, chain, gears or the like, such as in a standard driven pallet jack.

A battery pack 422 in the base 412 powers the motors 466, 467 and the rest of the pallet lift 410. The pallet lift 410 may in some aspects generally take the form of a pallet jack, with hydraulics or electric motors or actuators configured to lift the lower structure relative to the floor.

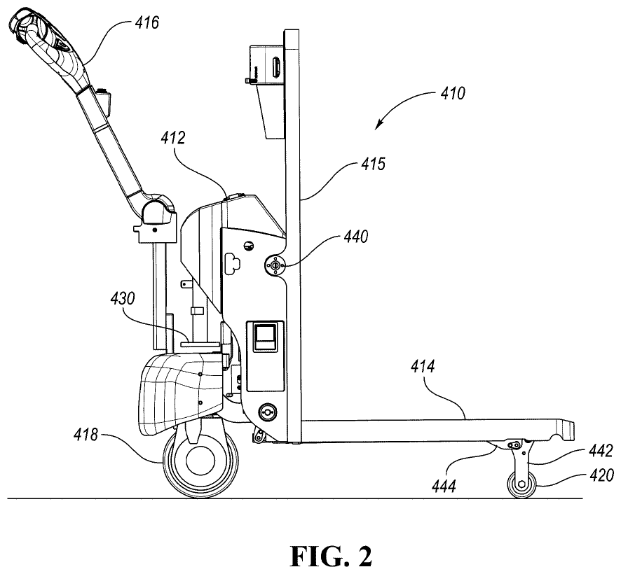

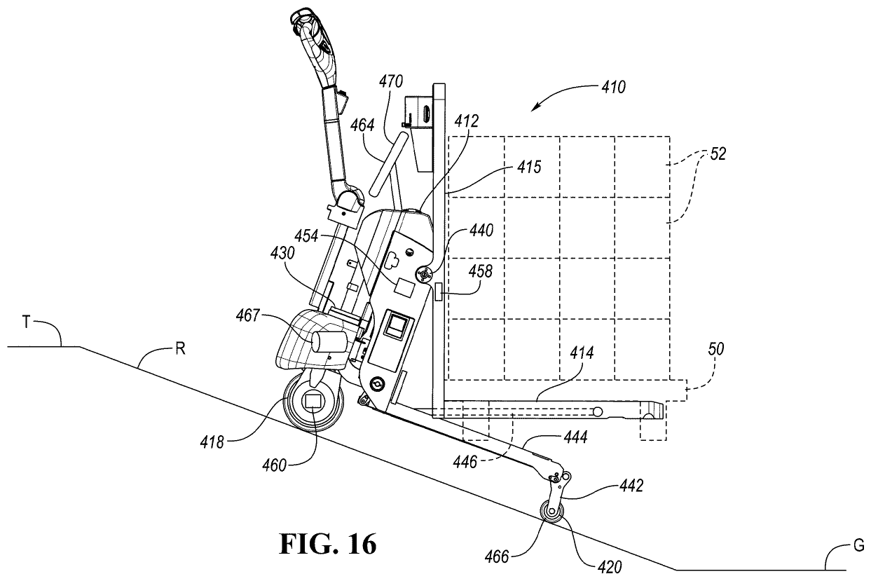

FIG. 2 is a side view of the pallet lift 410 in the raised position, such as would be used to raise a pallet (e.g. pallet 50 of FIG. 16) off the floor. As is known, a lift actuator 430 lifts the base 412 relative to the rear wheel 418. The lift actuator 430 may be a hydraulic cylinder, electric motor, linear actuator or other suitable actuator. Manual mechanical devices, such as levers and ratchets, could also be used. The lift actuator 430 is mounted between the rear wheel 418 and the base 412 and is configured to move the rear wheel 418 toward and away from the base 412 and, via linkage, to pivot the arms 442 and load wheels 420 toward and away from a lower structure 444 below the platform 414. The lift actuator 430 and its configuration for raising and lowering the lower structure 444 relative to the floor may be similar to a conventional pallet jack.

Alternatively, in applications where a pallet will not be used and product will be placed directly on the platform 414, the lift function is not necessary so the load wheels 420 and rear wheel 418 can be set at a fixed height and the lift actuator 430 would be eliminated.

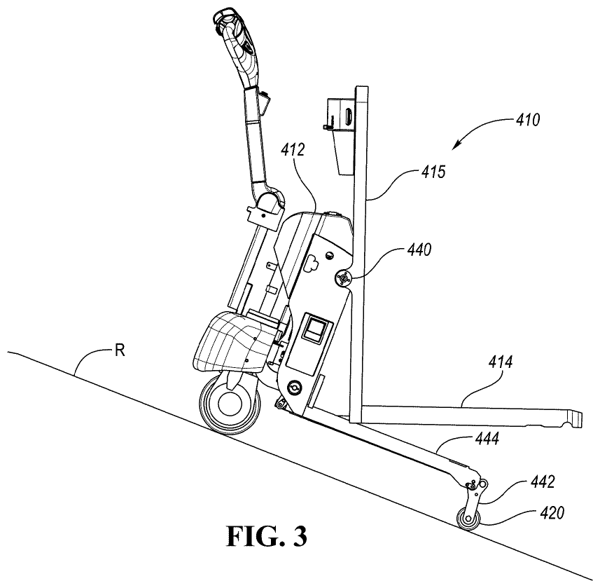

In FIG. 3, the load wheels 420 are still pivoted downward on arms 442 to raise the lower structure 444 and the platform 414, and the rear wheel 418 is also moved away from the base 412. Again, in this configuration, a pallet (not shown) supported on the platform 414 would be lifted from the floor for transport by the pallet lift 410. As also shown in FIG. 3, the platform 414 and backrest 415 are pivotable relative to the base 412. The upper end of the backrest 415 has been pivoted rearward about the axis 440, thereby raising the front end of the platform 414.

The pallet lift 410 is on a ramp R that is tilted relative to a horizontal plane of the floor/earth (which is perpendicular to gravity). The platform 414 and backrest 415 are pivoted rearward about axis 440 while the pallet lift 410 travels down the ramp R. Preferably the platform 414 and backrest 415 are pivoted so that the upper support surface of the platform 414 is substantially parallel to the floor (i.e. substantially perpendicular to gravity) or tilted rearward slightly (e.g. approximately two degrees, again, still considered substantially perpendicular to gravity). This may be performed automatically as described herein based upon sensor input, or this may be performed manually by the operator. In this manner, a load, such as a loaded pallet or an object or objects without a pallet, will be stable on the platform 414 as the pallet lift 410 travels down (or up) the ramp R.

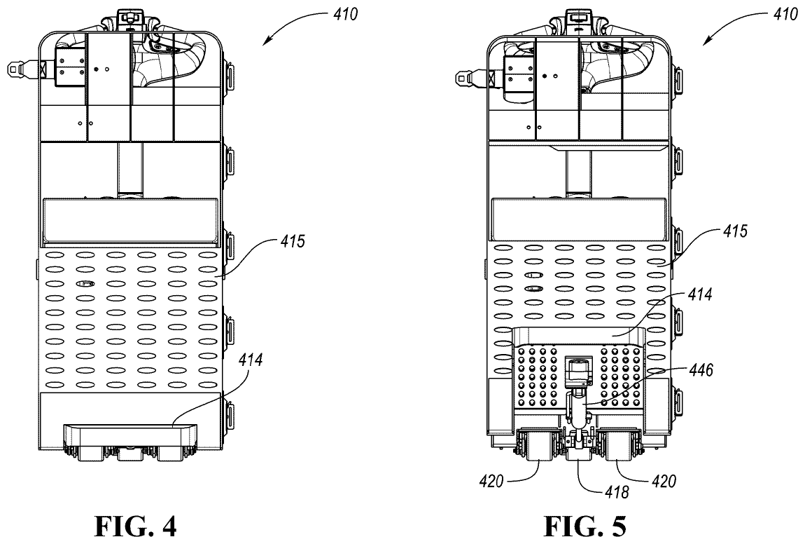

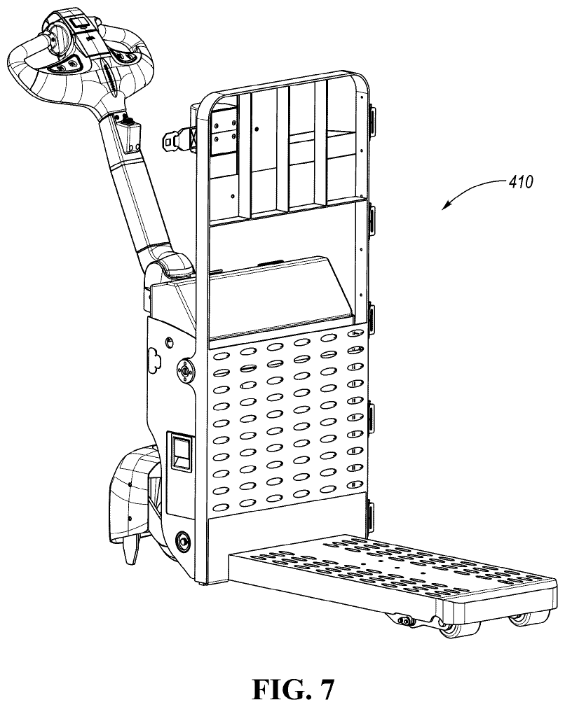

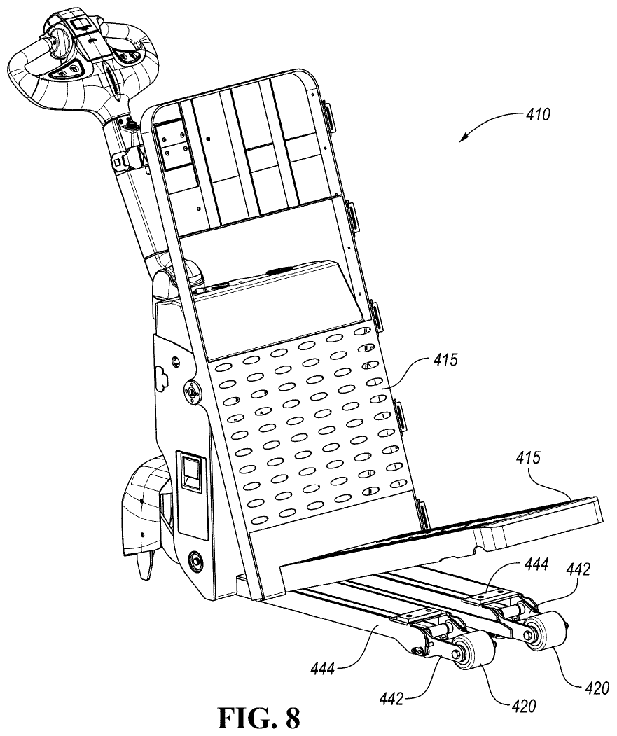

FIGS. 4-6 are front views of the pallet lift 410. FIGS. 7-9 are front perspective views of the pallet lift 410. In FIGS. 4 and 7, the platform 414 is in a lowered, horizontal position. In FIGS. 5 and 8, the platform 414 and backrest 415 are tilted rearward by a tilt actuator 446 secured to a forward end of the platform 414 and to the base 412. When the tilt actuator 446 expands, the forward end of the platform 414 is lifted, thereby tilting the platform 414 and backrest 415 rearward relative to the base 412 and the lower structure 444 as shown. The tilt actuator 446 may be a hydraulic cylinder, electric motor, linear actuator, or other actuator. Manual mechanical devices, such as levers and ratchets, could also be used.

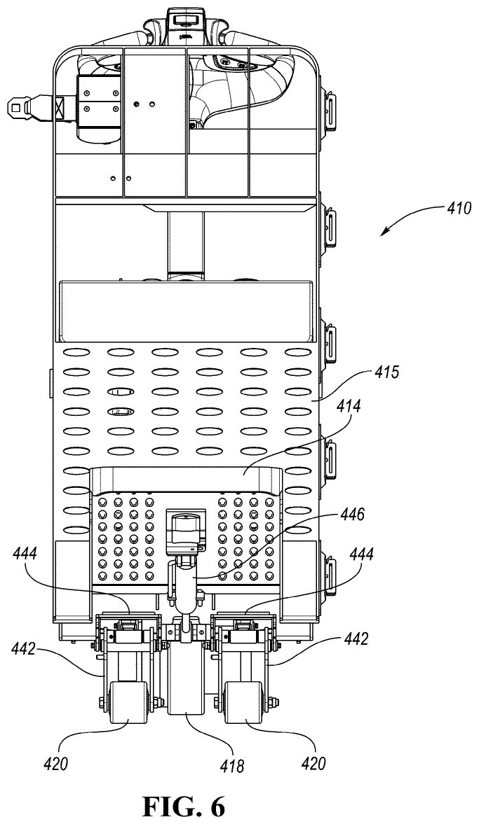

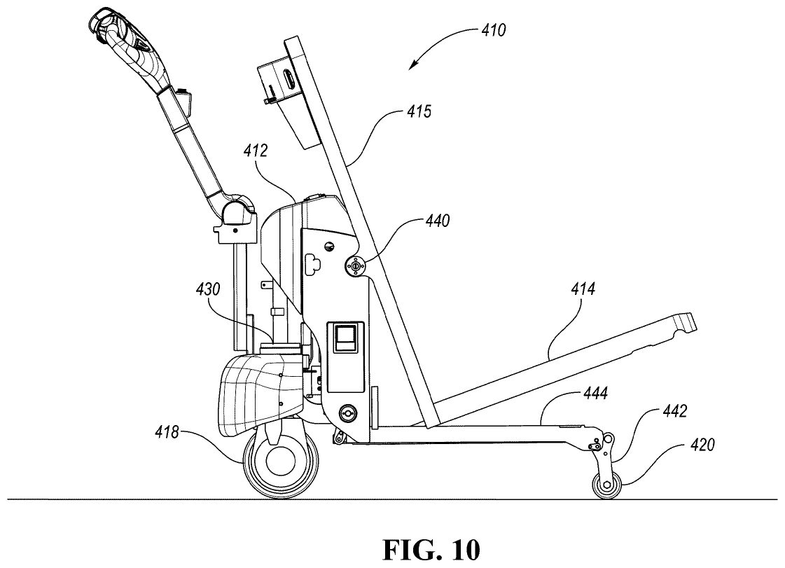

In FIGS. 6, 9 and 10, the lower structure 444, base 412, platform 414 and backrest 415 are raised upward relative to the floor and relative to the rear wheel 418 and the load wheels 420. The platform 414 and backrest 415 are also tilted rearwardly relative to the base 412 and the lower structure 444.

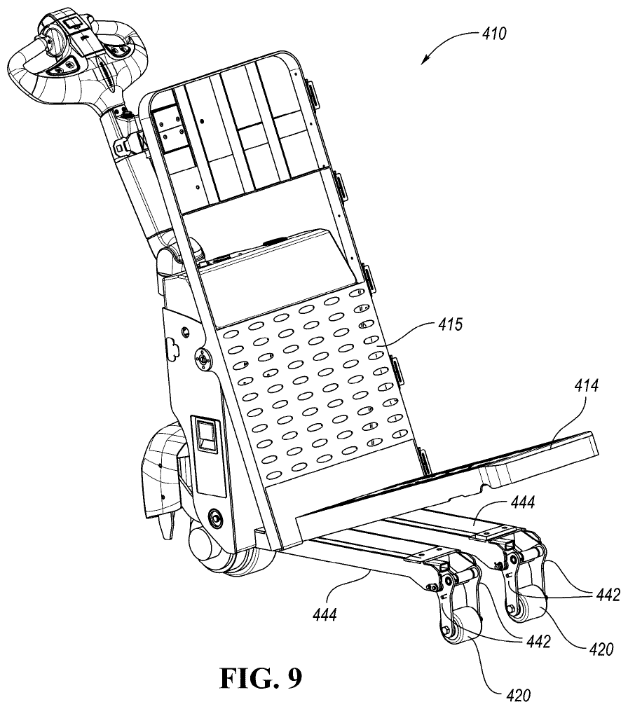

As can be seen in FIGS. 6 and 9, the lower structure 444 may comprise tines that are spaced apart and extend separately from the base 412. The pair of spaced-apart tines could be secured to one another at intervals or replaced with a single, continuous deck.

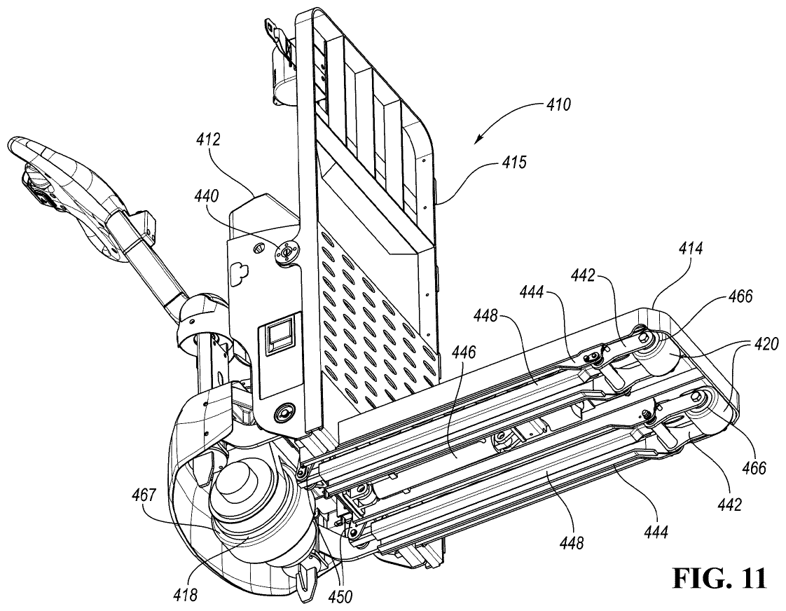

FIG. 11 is a bottom perspective view of the pallet lift 410. Linkage 450 is coupled to each of a pair of push rods 448 leading to each arm 442. As is known, the linkage 450 (via the lift actuator 430) forces the push rods 448 forward and rearward parallel to the lower structure 444. As is known, the arms 442 are pivotably coupled to the lower structure 444 about an arm axis. The push rods 448 are also pivotably coupled to the arms 442 at a pushrod axis offset from the arm axis. Forward and rearward motion of the push rods 448 thus causes the arms 442 to pivot relative to the lower structure 444, thereby moving the load wheels 420 toward and away from the lower structure 444.

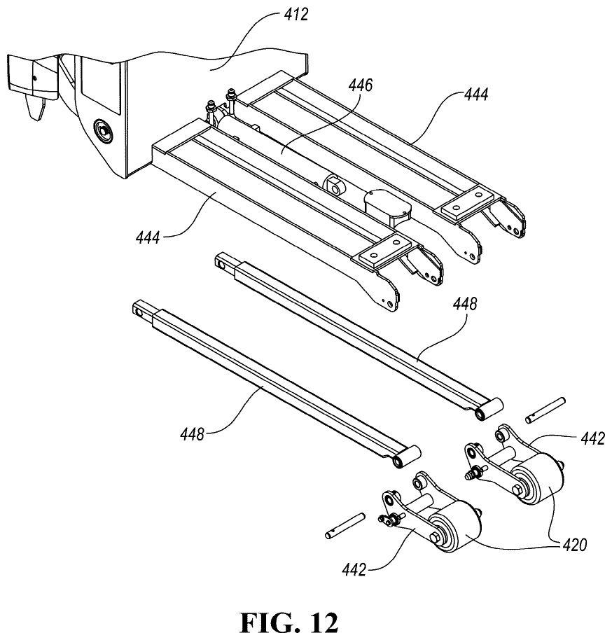

FIG. 12 is a partially exploded view of the pallet lift 410 with the platform 414 removed for visibility. The lower structure 444 extends forward from the base 412. The tilt actuator 446 is pivotably coupled to the base 412 between the tines of the lower structure 444. The push rods 448 are configured to be pivotably coupled to the arms 442 at pushrod axes offset from the arm axes about which the arms 442 pivot relative to the lower structure 444.

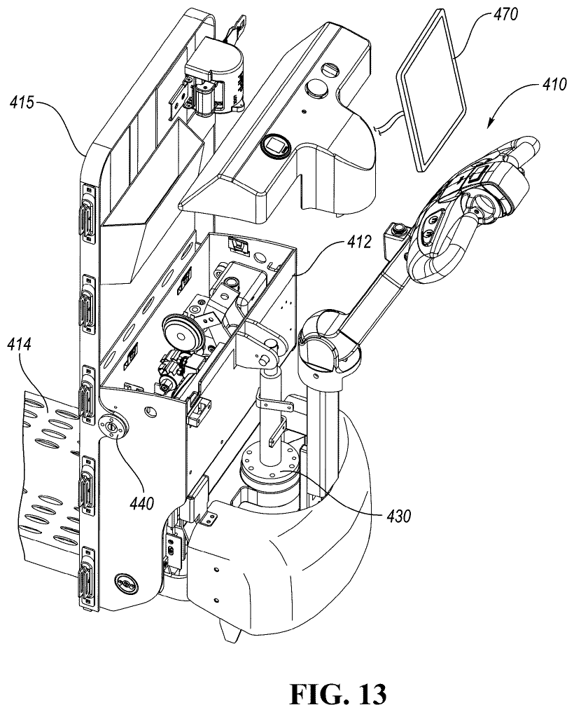

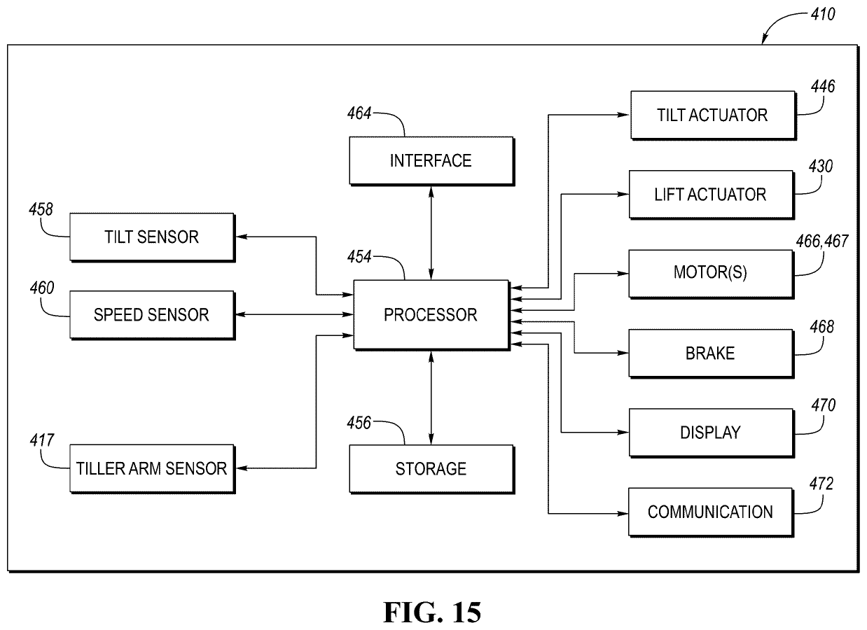

FIG. 13 is a partially exploded upper rear view of the base 412 of the pallet lift 410. The lift actuator 430 is secured to a rear wall of the base 412. FIG. 13 shows an optional display 470 mounted to the base 412, which faces the user during use. The display 470 could be part of a mobile device, such as a tablet having a processor 454 (FIG. 15), to provide a complete user interface.

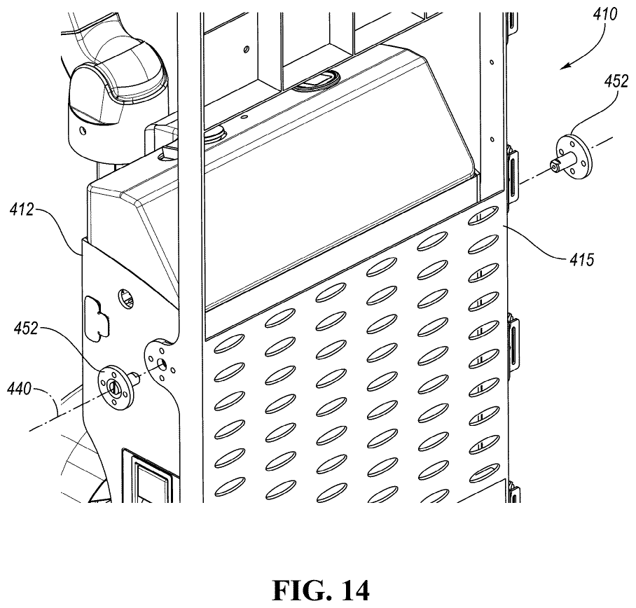

FIG. 14 is a partially exploded front view of the base 412 of the pallet lift 410. Fasteners 452 provide a pivoting hinge connection along axis 440 between the backrest 415 and the base 412.

FIG. 15 shows one possible partial schematic of the pallet lift 410. A processor 454 may be mounted in the base 412. The processor 454 is connected to electronic storage 456 storing computer instructions which when executed by the processor 454 causes the processor 454 to perform the functions described herein. Of course, the processor 454 is at least one processor and could include a plurality of processors including processors of different types at different locations, including a motor controller.

The processor 454 receives inputs from a tilt sensor 458, which may be a three-axis or two-axis accelerometer, or other sensor that generates a signal indicating its orientation relative to gravity. The tilt sensor 458 is mounted in a fixed orientation relative to the platform 414. For example, the tilt sensor 458 may be mounted to the backrest 415 or to the platform 414. Alternatively, the tilt sensor 458 could be mounted in a fixed orientation relative to the base 412 or the lower structure 444.

At least one speed sensor 460 is mounted to one of the load wheels 420 and/or the rear wheel 418. In one embodiment, there is a speed sensor 460 mounted to each of the load wheels 420 and the rear wheel 418 that sends speed information (i.e. rotational speed) to the processor 454. The processor 454 receives a signal from a user interface 464, which may be a touchscreen (e.g. display 470), microphone, buttons, switches, keyboard, trackpad, mouse, etc.

The processor 454 sends control signals to the tilt actuator 446 and the lift actuator 430 in the manner described herein. The processor 454 also generates control signals that control motors 466 coupled to or within the load wheels 420 and the motor 467 coupled to or within the rear wheel 418.

The processor 454 may include a motor controller module that separately controls the supply of power to each of the motors 466 powering the load wheels 420 and the motor 467 powering the rear wheel 418. For example, the motor controller could supply power to the load wheels 420 and the rear wheel 418 equally, or could supply power primarily to the load wheels 420 and only to the rear wheel 418 as needed (e.g. when traveling up an incline, or when detecting slippage by the load wheels 420, or when detecting that more power is needed), or it could supply power primarily to the rear wheel 418 and only to the load wheels 420 as needed (e.g. when traveling up an incline, or when detecting slippage by the rear wheel 418, or when detecting that more power is needed). The processor 454 also controls the motors 466 and/or 467 to provide braking to the load wheels 420 and rear wheel 418. The processor 454 may also control a brake 468 (if provided) on one or more of the load wheels 420 and rear wheel 418. The processor 454 provides more drive or braking to the motor 466,467 that is under the load in order to maintain traction and prevent slipping. This will result in increased performance when driving, slowing or stopping, especially when operating in a limited space environment or a more extreme environment (weather conditions, ramps, etc.).

The processor 454 may also control the hub motors 466 in load wheels 420 to provide differential steering. The two hub motors 466 are driven independently to provide differential steering, which maximizes maneuverability by minimizing the turn radius of the equipment. The processor 454 receives a steering input from the operator (e.g. via a sensor 417 measuring the position of the tiller arm 416, steering wheel, yoke system, etc.) and it adjusts the speeds of each hub motor 466 based on the steer angle. The sharper the turn angle, the more speed differential there will be between the two motors 466, with the speed of the load wheel on the outside of the turn exceeding the speed of the load wheel on the inside of the turn. This minimizes excessive tread wear due to wheel drag (e.g. wheel is not rolling while the pallet lift 410 is moving) while maintaining traction and minimizing turn radius.

Having multiple drive wheels (i.e. load wheels 420 and optionally rear wheel 418) individually controlled allows further control over the pallet lift 410 based on the terrain or conditions it is moving through. For example, this allows the pallet lift 410 to detect wheel slip, especially in inclement weather (rain, snow) or loose terrain (gravel) and adjust power to each drive motor 466, 467 accordingly to continue moving. With a single, standard electric pallet jack drive wheel, when wheel slip occurs in these scenarios the lift is typically stuck and requires manual pushing/pulling to free up if possible.

Wheel slip can be detected in any of several ways. The processor 454 could monitor the speed of the wheel 418 and/or wheels 420 relative to the speed of the lift 410 (i.e.

rotational speed of the wheel 418 and/or wheels 420 converted to an expected land speed compared to a land speed of the lift 410, which could be determined via GPS or accelerometers). Alternatively, or additionally, the processor 454 could monitor the multiple drive wheels (wheel 418 and/or wheels 420) relative to each other. For example, if the pallet lift 410 is driving in a straight line, the processor 454 would expect the multiple drive wheels to be providing the same speed. While the pallet lift 410 is turning, the processor 454 would reference the differential steering to know the relative rates of the drive wheels to determine if wheel slip is occurring.

In addition to the above to maintain traction to continue delivery, there may be other drive wheel control operations possible to maximize delivery efficiency. For example, to make a sharp turn, the motor 466 of one of the load wheels 420 could be “locked” so the pallet lift 410 turns about the fixed point. Optionally, the processor 454 could control the hub motors 466 to rotate in opposite directions, e.g. if the tiller arm sensor 417 determines this extreme position of the tiller arm 416.

As is also shown in FIG. 15, the processor 454 may also be connected to a wireless communication circuit 472 such as cell data, wifi, Bluetooth, etc.

FIG. 16 shows the pallet lift 410 carrying a pallet 50 on the platform 414. The pallet 50 is loaded with a stack of items 52. A ramp R extends from a floor of truck T to ground G. The ramp R may be inclined more than ten degrees. As the pallet lift 410 moves from the relatively level floor T of a truck onto the inclined ramp R, the tilt sensor 458 senses the change in orientation of the backrest 415 and platform 414. The processor 454 receives this signal from the tilt sensor 458 and commands the tilt actuator 446 to pivot the platform 414 and backrest 415 rearward until the tilt sensor 458 detects that the platform 414 is returned to generally level relative to gravity, i.e. perpendicular to gravity (or tilted rearward slightly, e.g. two degrees). As the load wheels 420 begin down the ramp R, the pallet lift 410 will gradually tilt and the pallet lift 410 will gradually extend the tilt actuator 446 pivoting the platform 414 more and more until the rear wheel 418 is also on the ramp R, which is when the pallet lift 410 will be tilted the most. Then, when the load wheels 420 reach the relatively level ground G, the pallet lift 410 will gradually return to level and the tilt actuator 446 will be gradually retracted, pivoting the platform 414 downward to maintain the platform 414 perpendicular to gravity (or tilted slightly rearward). When the rear wheel 418 reaches the ground G, the platform 414 will be returned to an orientation generally parallel to the lower structure 444, again, substantially orthogonal to gravity.

### Active Speed Control

During use of the pallet lift 410, a fast speed (like fast walking speed) would be needed for use on flat ground G and a very slow speed (around 1 mph) would be needed to descend a ramp R safely. The processor 454 controls the speed of the pallet lift 410 by controlling the motors 466, 467 (and the brake 468, if provided, FIG. 15). In FIG. 16, the motor 467 for the rear wheel 418 is shown as a standard electric pallet jack drive motor 466 connected to the rear wheel 418, but again, motor 467 could be a hub motor within the rear wheel 418. Hub motors 466 within the load wheels 420 are also used.

In order to improve ease of use and operator safety while descending a ramp, a speed limiter could be automatically implemented by the processor 454 once the pallet lift 410 detects that it is descending a ramp, such as by detecting a tilt in excess of a threshold by the tilt sensor 458. The speed of descent is more controllable if all of the wheels 418, 420 are powered by motors 467, 466 because all the motors 466, 467 can provide braking to all the wheels 418, 420. This increases the braking power and traction of the pallet lift 410 when braking. Additionally, the motors 466, 467 could optionally provide regenerative braking to recharge the battery while slowing the pallet lift 410 on steep inclines.

Optionally, the pallet lift 410 could also have a button or switch in the user interface 464 (shown in FIG. 16 as a UI on display 470, which may be a touch screen) which turns on “ramp mode” that activates the speed control and adjusts the Active Stability Control and Active Traction Control settings for optimal ramp settings. Pressing the “ramp mode” button may also enable the processor 454 to activate the tilt actuator 446 based upon input from the tile sensor 458, such that when the tilt actuator 446 detects that it being tilted relative to gravity (e.g. as the pallet lift 410 goes down the ramp), the processor 454 receives this signal from the tilt actuator 446 and sends counteractive signals to the tilt actuator 446 to maintain the platform 414 perpendicular to gravity (or tilted slightly back). When the load wheels 420 hit the level ground after the ramp, the pallet lift 410 starts to return to level ground, which is detected by the tilt sensor 458, so the processor 454 sends signals to the tilt actuator 446 to move the platform 414 back toward the lower structure 444 to maintain the upper surface of the platform 414 perpendicular to gravity (or tilted slightly back).

### Active Stability Control

Since the stability of the pallet lift 410 is key to preventing a tip-over of the system, one embodiment could use the tilt sensor 458 to detect the side to side angle (roll) of the pallet lift 410 as well as the pitch, and if the angle of the lift is past a pre-determined safe angle, the electronic controller could take action to prevent tipping, such as slowing or stopping the pallet lift 410 by reducing power to the motors 466 in the rear wheel 418 and the load wheels 420 or applying the brake 468, lowering the load height by releasing the lift actuator 430, increasing or decreasing the tilt angle by appropriately controlling the tilt actuator 446 or a combination thereof.

The speed sensor 460, tilt sensor 458, user interface 464, and the multiple drive wheels 418,420 are used by the processor 454 to reduce and potentially eliminate unsafe maneuvers such as speeding and tipping via a sharp turn. The processor 454 has real time access to all these components and inputs such that it proactively and automatically determines an unsafe condition and limits speed, acceleration, braking to potentially prevent an accident from occurring.

### Active Traction Control

The pallet lift 410 may be driven on various surfaces in a range of conditions (hot, cold, rain, snow, aluminum ramps, steel ramps, pavement, concrete, dirt, wood etc.) and in order to improve traction, the processor 454 could detect drive wheel (in this case, the rear wheel 418) slip and take action to reduce the wheel slip and help regain control. This would be specifically helpful while on a ramp, since losing traction while descending the ramp could cause loss of steering and loss of speed control.

One method to detect drive wheel slip is by comparing the pallet lift 410 acceleration as detected by an accelerometer (such as tilt sensor 458) to the drive wheel speed as provided by the speed sensor 460 (which may be a drive wheel encoder) and comparing these inputs to a function which characterizes normal acceleration vs wheel speed. When a large enough delta between the actual acceleration vs expected acceleration exists, the processor 454 can take action to reduce wheel slip.

### Active Load Control

The pallet lift 410 could sense the weight of the load and automatically adjust the previously mentioned Active Stability Control, Active Traction Control and Active Speed Control settings to suit the load. The load sensing could be done by measuring the line pressure of the hydraulic lifting mechanism of the tilt actuator 446 or by load cells placed under the load platform or by deriving it from the energy required to accelerate the load.

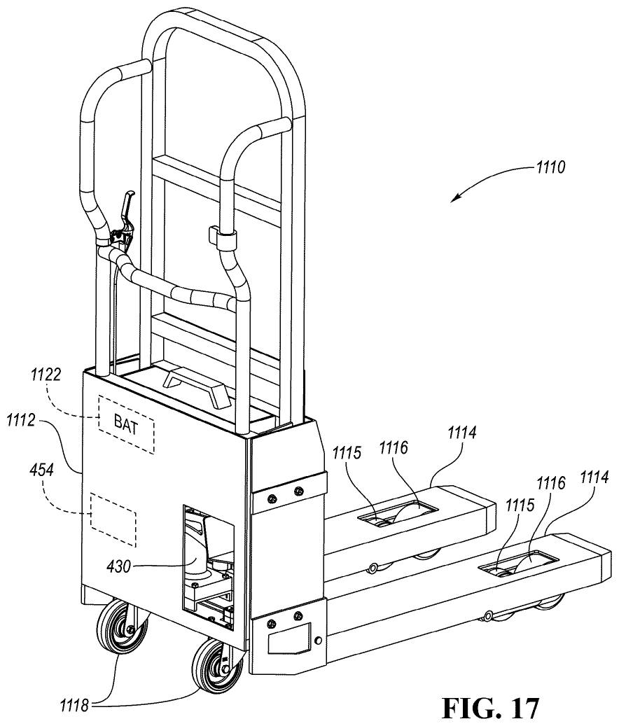

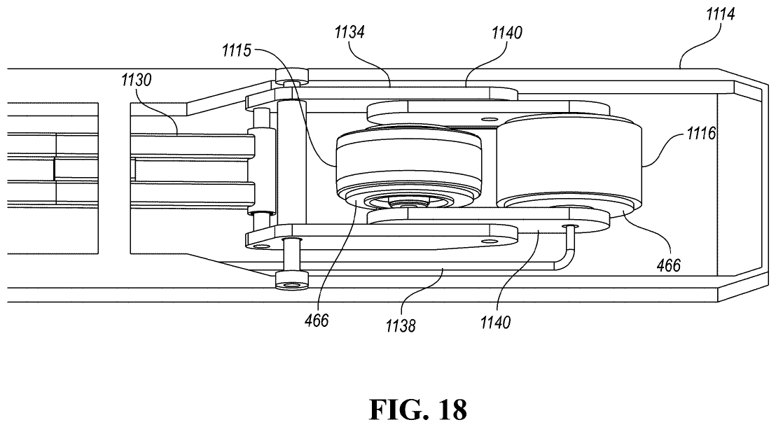

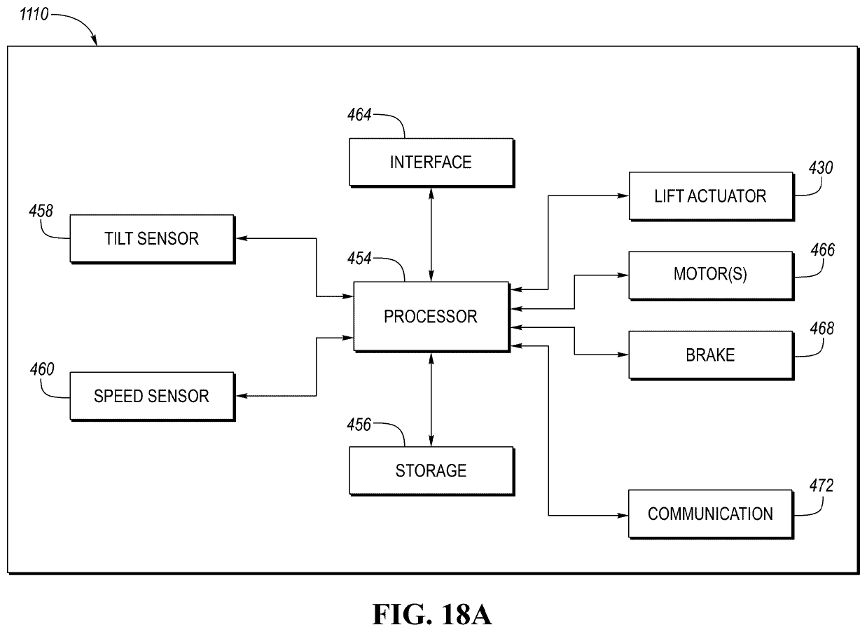

FIGS. 17 and 18 show a lift 1110 according to another embodiment. Referring to FIG. 7, the lift includes a base 1112 connected to a pair of tines 1114. One or more rear wheels 1118 support the base 1112. Each tine 1114 includes a primary load wheel 1115 adjacent an outer end thereof. In this embodiment, a secondary load wheel 1116 is operated in tandem with the primary load wheel 1115 in each tine 1114.

Referring to FIG. 18, the primary load wheel 1115 and secondary load wheel 1116 are each mounted to ends of a pair of tandem plates 1140. The tandem plates 1140 are pivotably mounted near their centers to outer ends of the arms 1134, which raise and lower the primary load wheel 1115 and secondary load wheel 1116 relative to the tine 1114 (to raise and lower the tine 1114). A hub motor 466 is mounted within each of the primary load wheel 1115 and the secondary load wheel 1116.

The pallet lift 1110 includes a lift actuator 430 (such as a hydraulic actuator or alternative an electric actuator or manual ratchet mechanism) that lifts the base 1112 and is coupled to push rods 1130 in each of the tines 1114 to move the load wheels 1115, 1116 toward and away from the respective tines 1114, thereby lowering and raising the tines 1114 relative to the floor or ground.

Both the primary load wheel 1115 and secondary load wheel 1116 contact the floor or ground. This provides load distribution between the secondary load wheel 1116 and the primary load wheel 1115 and may facilitate easier climbs over thresholds, for example. Additionally, with a hub motor 466 within each of the primary load wheel 1115 and the secondary load wheel 1116, the hub motors 466 can each be less powerful and therefore have smaller diameters. As a result, the primary load wheel 1115 and the secondary load wheel 1116 can have a smaller diameter and/or have more total drive power than a single load wheel would. A conduit 1138 in each tine 1114 provides power from a battery 1122 to the hub motors 466. Again, the lift 1110 may be controlled by the processor 454.

Referring to FIG. 18A, the lift 1110 may utilize the processor 454, storage 456, tilt sensor 458 and speed sensor 460 to control the hub motors 466 in the manner described above, including providing the differential steering as described above. The processor 454 is connected to electronic storage 456 storing computer instructions which when executed by the processor 454 causes the processor 454 to perform the functions described herein. Again, the processor 454 is at least one processor and could include a plurality of processors including processors of different types at different locations, including a motor controller.

The processor 454 receives inputs from a tilt sensor 458, which may be a three-axis or two-axis accelerometer, or other sensor that generates a signal indicating its orientation relative to gravity. The tilt sensor 458 is mounted in a fixed orientation relative to the base 1112.

At least one speed sensor 460 is mounted to one of the load wheels 1115, 1116 and/or the rear wheel 1118. In one embodiment, there is a speed sensor 460 mounted to each of the load wheels 1115, 1116 and the rear wheel 1118 that sends speed information to the processor 454. The processor 454 receives a signal from a user interface 464, which may be a touchscreen, microphone, buttons, switches, keyboard, trackpad, mouse, hand lever, etc.

The processor 454 sends control signals to the lift actuator 430 to raise and lower the tines 1114. The processor 454 also generates control signals that control hub motors 466 within the load wheels 1115, 1116.

The processor 454 may include a motor controller module that separately controls the supply of power to each of the motors 466 powering the load wheels 1115, 1116. For example, the motor controller could supply power to the load wheels 1115, 1116 equally, or could supply power primarily to the primary load wheels 1115 and only to the secondary load wheels 1116 as needed (e.g. when traveling up an incline, or when detecting slippage by the load wheels 1115, or when detecting that more power is needed), or vice versa. The processor 454 also controls the motors 466 to provide braking to the load wheels 1115, 1116. The processor 454 may also control a brake 468 (if provided) on one or more of the load wheels 1115, 1116 and rear wheel 1118.

The processor 454 may also control the hub motors 466 in load wheels 1115, 1116 to provide differential steering. The hub motors 466 in the load wheels 1115, 1116 under one tine 1114 are driven independently of the hub motors 466 in the load wheels 1115, 1116 under the other tine 1114 to provide differential steering, which maximizes maneuverability by minimizing the turn radius of the equipment. The processor 454 may receive a steering input from the operator (e.g. via user interface 464) and it adjusts the speeds of each hub motor 466 based on the steer angle. The sharper the turn angle, the more speed differential there will be between the motors 466 under one tine 1114 and the motors 466 under the other tine 1114, with the speed of the load wheels 1115, 1116 on the outside of the turn exceeding the speed of the load wheels 1115, 1116 on the inside of the turn. This minimizes excessive tread wear due to wheel drag (e.g. wheel is not rolling while the pallet lift 1110 is moving) while maintaining traction and minimizing turn radius.

Having multiple drive wheels (i.e. load wheels 1115, 1116) individually controlled allows further control over the pallet lift 1110 based on the terrain or conditions it is moving through. For example, this allows the pallet lift 1110 to detect wheel slip, especially in inclement weather (rain, snow) or loose terrain (gravel) and adjust power to each drive motor 466 accordingly to continue moving.

Wheel slip can be detected in any of several ways. The processor 454 could monitor the speed of the wheels 1118 and/or wheels 1115, 1116 relative to the speed of the lift 1110 (i.e. rotational speed of the wheels 1118 and/or wheels 1115,1116 converted to an expected land speed compared to a land speed of the lift 1110, which could be determined via GPS or accelerometers). Alternatively, or additionally, the processor 454 could monitor the multiple drive wheels (wheels 1115, 1116) relative to each other. For example, if the pallet lift 1110 is driving in a straight line, the processor 454 would expect the wheels 1115, 1116 under one tine 1114 to be providing the same speed as the wheels 1115, 1116 under the other tine 1114. While the pallet lift 1110 is turning, the processor 454 would reference the differential steering to know the relative rates of the wheels 1115, 1116 to determine if wheel slip is occurring.

In addition to the above to maintain traction to continue delivery, there may be other drive wheel control operations possible to maximize delivery efficiency. For example, to make a sharp turn, the motors 466 under one of the tines 1114 could be “locked” so the pallet lift 1110 turns about the fixed point. Optionally, the processor 454 could control the hub motors 466 under one tine 1114 to rotate in a direction opposite that of the hub motors 466 under the other tine 1114, e.g. if the processor 454 determines that such a sharp turn is desired by the user, e.g. via user interface 464.

As is also shown in FIG. 18A, the processor 454 may also be connected to a wireless communication circuit 472 such as cell data, wifi, Bluetooth, etc.

The processor 454 implements in the lift 1110 the Active Speed Control, Active Stability Control, Active Traction Control, and/or Active Load Control features described above with respect to the first embodiment.

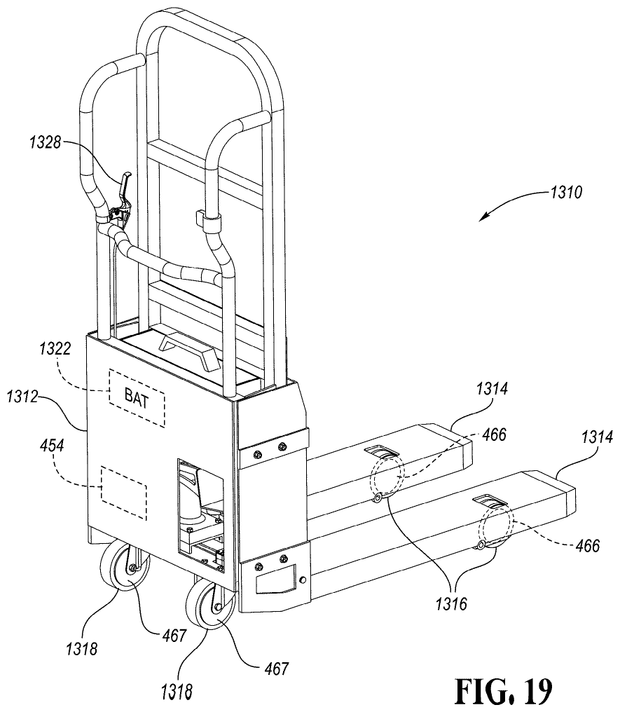

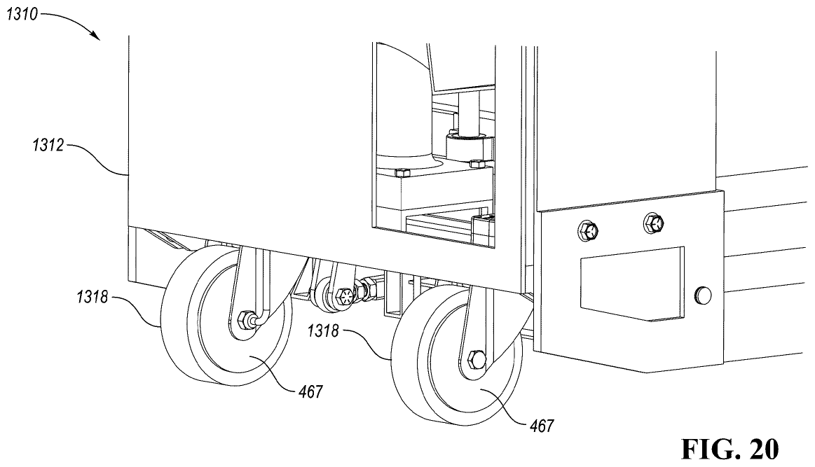

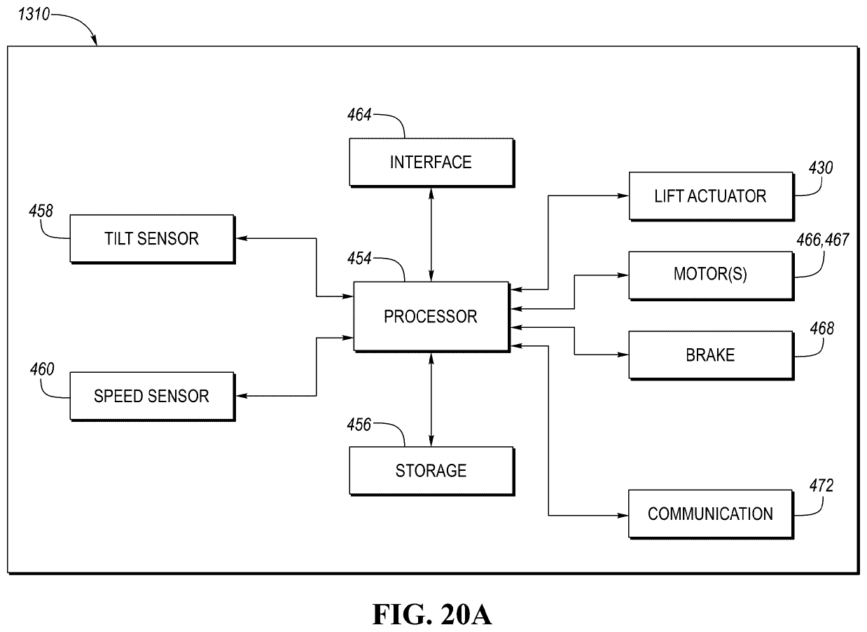

FIGS. 19 and 20 show a powered lift 1310 according to another embodiment. The lift 1310 includes a base 1312 having tines 1314 extending forward from the base 1312. A load wheel 1316 supports outer ends of each of the tines 1314. In this embodiment, the wheels 1318 under the base 1312 including hub motors 467 (or alternatively, motors driving the wheels 1318 via belts, chains, gears, etc) and the load wheels 1316 include hub motors 466, again controlled by a throttle 1328 and processor 454. Locating hub motors 467 under the base 1312 in addition to the hub motors 466 under the tines 1314 permits larger wheels 1318 and larger hub motors 467 to be used under the base 1312. This may permit the use of smaller hub motors 466 under the tines 1314. The hub motors 466 would be powered by the battery 1322 as controlled by the throttle control 1328 and processor 454. As in the previous embodiment, the load wheels 1316 are movable toward and away from the tines 1314 to lower and raise the tines 1314 via a lift actuator moving push rods parallel to the tines 1314.

Referring to FIG. 20A, the lift 1310 may also utilize the processor 454, storage 456, tilt sensor 458 and speed sensor 460 of FIG. 15 to control the hub motors 466 in the manner described above, including the differential steering.

The processor 454 receives inputs from the tilt sensor 458, which may be a three-axis or two-axis accelerometer, or other sensor that generates a signal indicating its orientation relative to gravity. The tilt sensor 458 is mounted in a fixed orientation relative to the base 1312.

At least one speed sensor 460 may be mounted to at least one of the load wheels 1316 and/or at least one of the rear wheels 1318. The processor 454 may receive a signal from a user interface 464, which may be a touchscreen, microphone, buttons, switches, keyboard, trackpad, mouse, hand lever, etc.

The processor 454 sends control signals to the lift actuator 430 to raise and lower the tines 1314. The processor 454 also generates control signals that control motors 466 within the load wheels 1316 and the motors 467 within the rear wheels 1318.

The processor 454 may include a motor controller module that separately controls the supply of power to each of the motors 466 powering the load wheels 1316 and the motor 467 powering the rear wheel 1318. For example, the motor controller could supply power to the load wheels 1316 and the rear wheel 1318 equally, or could supply power primarily to the load wheels 1316 and only to the rear wheel 1318 as needed (e.g. when traveling up an incline, or when detecting slippage by the load wheels 1316, or when detecting that more power is needed), or it could supply power primarily to the rear wheel 1318 and only to the load wheels 1316 as needed (e.g. when traveling up an incline, or when detecting slippage by the rear wheel 1318, or when detecting that more power is needed). The processor 454 also controls the motors 466 and/or motors 467 to provide braking to the load wheels 1316 and rear wheel 1318. The processor 454 may also control a brake 468 (if provided) on one or more of the load wheels 1316 and rear wheel 1318. The processor 454 provides more drive or braking to the motor 466,467 that is under the load in order to maintain traction and prevent slipping. This will result in increased performance when driving, slowing or stopping, especially when operating in a limited space environment or a more extreme environment (weather conditions, ramps, etc.).

The processor 454 may also control the hub motors 466 in load wheels 1316 to provide differential steering. The two hub motors 466 are driven independently to provide differential steering, which maximizes maneuverability by minimizing the turn radius of the equipment. The processor 454 receives a steering input from the operator (e.g. via user interface) and it adjusts the speeds of each hub motor 466 based on the steer angle. The sharper the turn angle, the more speed differential there will be between the two motors 466, with the speed of the load wheel 1316 on the outside of the turn exceeding the speed of the load wheel 1316 on the inside of the turn. This minimizes excessive tread wear due to wheel drag (e.g. wheel is not rolling while the pallet lift 1310 is moving) while maintaining traction and minimizing turn radius.

Having multiple drive wheels (i.e. load wheels 1316 and optionally rear wheels 1318) individually controlled allows further control over the pallet lift 1310 based on the terrain or conditions it is moving through. For example, this allows the pallet lift 1310 to detect wheel slip, especially in inclement weather (rain, snow) or loose terrain (gravel) and adjust power to each drive motor 466, 467 accordingly to continue moving.

Wheel slip can be detected in any of several ways. The processor 454 could monitor the speed of the wheel 1318 and/or wheels 1316 relative to the speed of the lift 1310 (i.e. rotational speed of the wheel 1318 and/or wheels 1316 converted to an expected land speed compared to a land speed of the lift 1310, which could be determined via GPS or accelerometers). Alternatively, or additionally, the processor 454 could monitor the multiple drive wheels (wheel 1318 and/or wheels 1316) relative to each other. For example, if the pallet lift 1310 is driving in a straight line, the processor 454 would expect the multiple drive wheels to be providing the same speed. While the pallet lift 1310 is turning, the processor 454 would reference the differential steering to know the relative rates of the drive wheels to determine if wheel slip is occurring.

In addition to the above to maintain traction to continue delivery, there may be other drive wheel control operations possible to maximize delivery efficiency. For example, to make a sharp turn, the motor 466 of one of the load wheels 420 could be “locked” so the pallet lift 1310 turns about the fixed point. Optionally, the processor 454 could control the hub motors 466 to rotate in opposite directions.

As is also shown in FIG. 20A, the processor 454 may also be connected to a wireless communication circuit 472 such as cell data, wifi, Bluetooth, etc.

The processor 454 implements in the lift 1310 the Active Speed Control, Active Stability Control, Active Traction Control, and/or Active Load Control features described above with respect to the first embodiment.

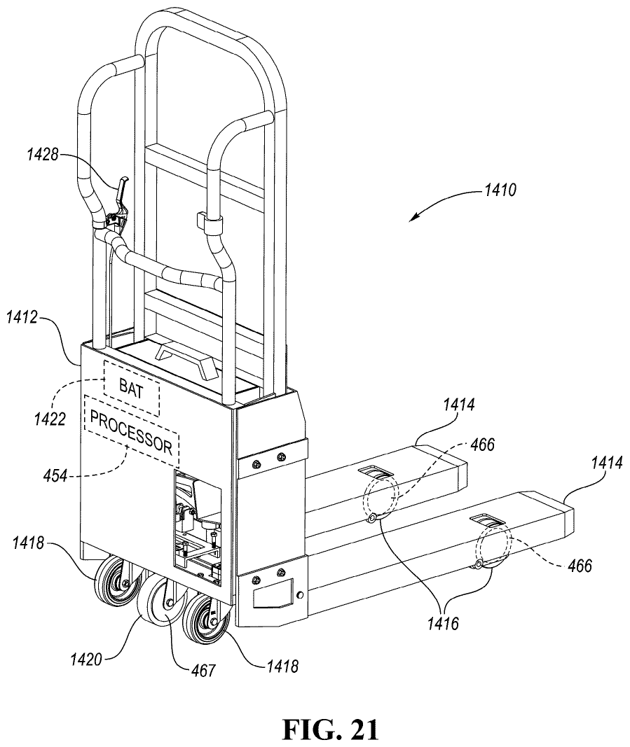

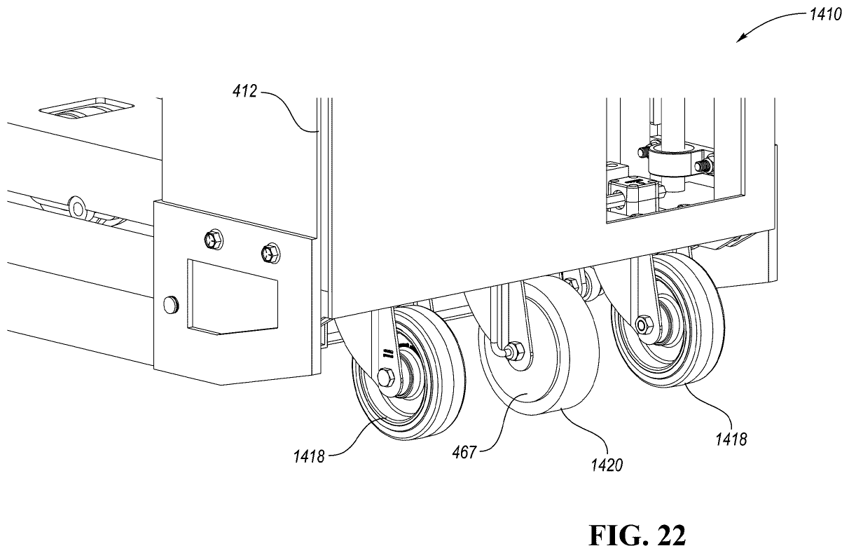

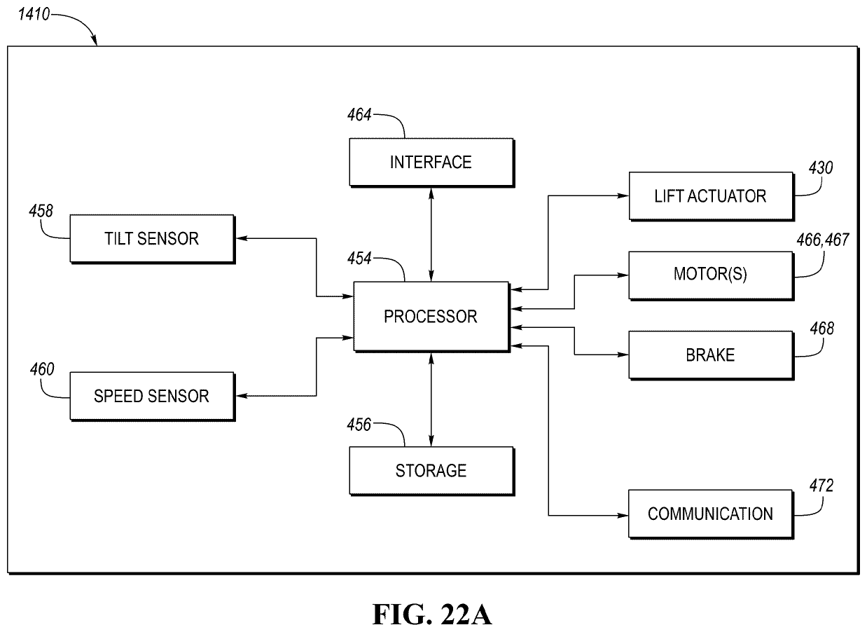

FIGS. 21 and 22 show a powered lift 1410 according to another embodiment. The lift 1410 includes a base 1412 having tines 1414 extending forwardly therefrom. A load wheel 1416 supports outer ends of each of the tines 1414. A hub motor 466 is mounted within each load wheel 1416. In this embodiment, under the base 1412, there are two free-spinning wheels 1418 and a single drive wheel 1420 therein mounted between the free-spinning wheels 1418. A hub motor 467 is within the drive wheel 1420. The hub motors 466, 467 are controlled by the throttle 1428 (or other user interface) and the processor 454.

As in the previous embodiments, the load wheels 1416 are movable toward and away from the tines 1414 to lower and raise the tines 1414 (via a lift actuator and push rods). As shown in FIG. 22A, the lift 1410 may also utilize the processor 454, storage 456, tilt sensor 458 and speed sensor 460 of FIG. 20A to control the hub motors 466, 467 in the manner described above, including providing the differential steering, Active Speed Control, Act Stability Control, Active Traction Control, and Active Load Control features described above.

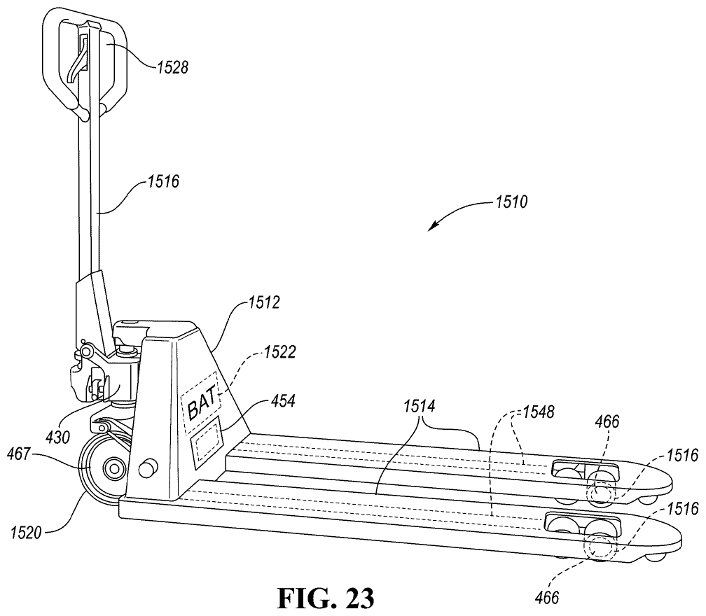

FIG. 23 shows a pallet lift according to another embodiment, which is in the form factor of a standard pallet jack 1510. The pallet jack 1510 includes a lift actuator 430 (such as a hydraulic actuator or alternative an electric actuator or manual ratchet mechanism) that lifts the base 1512 and is coupled to push rods 1548 in each of the tines 1514 to move the load wheels 1516 toward and away from the respective tines 1514, thereby lowering and raising the tines 1514 relative to the floor.

A rear wheel 1520 supports the base 1512. A tiller arm 1515 is used to steer the pallet jack 1510 by pivoting the rear wheel 1520 about a vertical axis, as is known.

In this embodiment, each of the load wheels 1516 has a hub motor 466 for rotatably driving the load wheel 1516 to move the pallet lift 1510. The rear wheel 1520 may also have a hub motor 467 therein for driving the pallet lift 1510. The hub motors 466, 467 are all powered by a battery 1522 in the base 1512 and may be controlled by the processor 454 based upon input from a throttle 1528 on the tiller arm 1515 or other user interface. The processor 454 may supply power equally to all three hub motors 466, 467 or may supply power primarily to the rear wheel 1520 hub motor 467 and only to the load wheel 1516 hub motors 466 as needed (or vice versa). The lift 1510 may also utilize the processor 454, storage 456, tilt sensor 458 and speed sensor 460 of FIG. 22A to control the hub motors 466, 467 in the manner described above, including providing the differential steering, Active Speed Control, Act Stability Control, Active Traction Control, and Active Load Control features described above.

In accordance with the provisions of the patent statutes and jurisprudence, exemplary configurations described above are considered to represent a preferred embodiment of the invention. However, it should be noted that the invention can be practiced otherwise than as specifically illustrated and described without departing from its spirit or scope. Alphanumeric identifiers on method claim steps are for ease of reference in dependent claims only and do not signify a required sequence of steps unless other explicitly recited in the claims.

What is claimed is:

1. A pallet lift comprising:
a base;
at least one platform for supporting an object thereon, the at least one platform extending forward of the base;
a plurality of load wheels below the at least one platform and configured to move toward and away from the at least one platform to selectively lower and raise the at least one platform;
a plurality of load motors, each configured to drive one of the plurality of load wheels;
at least one rear wheel below the base; and
at least one processor programmed to control the plurality of load motors to provide differential steering to the pallet lift.

2. The pallet lift of claim 1 further including:
a tiller arm configured to pivot the at least one rear wheel about a vertical axis; and
a tiller arm sensor generating an output indicating a steering angle of the tiller arm;
wherein the at least one processor is programmed to control the plurality of load motors to provide differential steering to the pallet lift based upon the output from the tiller arm sensor.

3. The pallet lift of claim 1 further including a steering angle sensor generating an output indicating a desired steering angle from a user, wherein the at least one processor is programmed to control the plurality of load motors to provide differential steering to the pallet lift based upon the output from the steering angle sensor.

4. The pallet lift of claim 1 further including a speed sensor monitoring a speed of each of the plurality of load wheels and sending speed information to the at least one processor, wherein the at least one processor is programmed to detect slippage of at least one of the plurality of load wheels.

5. The pallet lift of claim 4 wherein the at least one processor is programmed to control the plurality of load motors in response to the detection of slippage.

6. The pallet lift of claim 1 further including a rear motor powering each of the at least one rear wheel.

7. The pallet lift of claim 6 further including a speed sensor monitoring a speed of each of the plurality of load wheels an each of the at least one rear wheel and sending speed information to the at least one processor, wherein the at least one processor is programmed to detect slippage of at least one of the plurality of load wheels and the at least one rear wheel.

8. The pallet lift of claim 7 wherein the at least one processor is programmed to control the plurality of load motors and the rear motor in response to the detection of slippage.

9. The pallet lift of claim 1 wherein the at least one processor is programmed to control a speed of an outside one of the plurality of load wheels to be higher than a speed of an inside one of the plurality of load wheels while the pallet lift is turning.

10. The pallet lift of claim 1 wherein the at least one processor is programmed to lock one of the plurality of load wheels while driving an other of the plurality of load wheels during a turn.

11. The pallet lift of claim 1 wherein the at least one processor is programmed to drive one of the plurality of load wheels in a first direction while driving an other of the plurality of load wheels in a second direction opposite the first direction during a turn.

12. A method for controlling a pallet lift including:
a) moving a plurality of load wheels away from a support platform in order to raise the support platform;
b) receiving a steering input from a user; and
c) in response to step b), driving an outer one of a plurality of load wheels at a higher rate than that of an inner one of a plurality of load wheels.

13. The method of claim 12 wherein step a) includes receiving the steering input from a tiller arm sensor coupled to a tiller arm configured to pivot a rear wheel of the pallet lift.

14. The method of claim 12 wherein step c) includes locking the inner one of the plurality of load wheels.

15. The method of claim 12 wherein step c) includes driving the outer one of the plurality of load wheels in a first direction and driving the inner one of the plurality of load wheels in a second direction opposite the first direction.
